(19) United States
(12) Patent Application Publication
(10) Pub. No.: US 2017/0039615 A1
(43) Pub. Date: Feb. 9, 2017

(54) Personalized Shopping Mechanism

(71) Applicant: Intel Corporation, Santa Clara, CA (US)

(72) Inventors: Vadim Gore, Beaverton, OR (US); David McBride, Santa Clara, CA (US); Jeffrey B. Ponsness, Hillsboro, OR (US); David R. Elfi, Cordoba (AR)

(73) Assignee: Intel Corporation, Santa Clara, CA (US)

(21) Appl. No.: 14/818,383

(22) Filed: Aug. 5, 2015

(51) Int. Cl. G06Q 30/06; G06Q 30/02

(52) U.S. Cl. CPC G06Q 30/0613; G06Q 30/0269; G06Q 30/0246

(57) ABSTRACT

A network is described. The network includes a profile server to manage fashion analytics data for a plurality of consumers and a plurality of concierge profiles, a first computing device having a consumer application to generate a consumer fashion profile and communicate fashion analytics data associated with the consumer fashion profile with the profile server and a second computing device having a concierge application to generate a first concierge profile and communicate the first concierge profile and the fashion analytics data with the profile server.

### FIELD

Embodiments described herein generally relate to wearable computing. More particularly, embodiments relate to data services provided for wearable devices.

### BACKGROUND

It is often realized that consumer shopping is a task that requires an abundance of time. Shoppers once relied on a familiar salesperson, such as an owner of a local general store, to assist in finding desired items for purchase. Drawing on knowledge of a customer enabled the salesperson to quickly locate a suitable product, as well as suggest additional items the customer hadn't thought of purchasing.

A new generation of consumers lead busy lives and have become accustomed to expect a personalized experienced while shopping, socializing and watching content online. However, shorthanded, and often poorly informed, floor staff at many retail stores cannot replicate the personal touch that shoppers once relied on. Thus, consumers find researching and shopping on the Internet far more convenient than brick-and-mortar visits. As a result, foot traffic to brick-and-mortar stores has been on a continuous decline. For instance, according to retail analytics, store traffic during the 2014 holiday shopping season was down 7%, another down year in a string of down years.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates one embodiment of a computing device.

FIG. 2 illustrates one embodiment of a personalized shopping network.

FIG. 3 illustrates one embodiment of an analytics platform flow.

FIG. 4 illustrates one embodiment of a personalized shopping environment.

FIG. 5 is a flow diagram illustrating one embodiment of a personalized shopping process.

FIGS. 6A-6G illustrate embodiments of processes performed during a personalized shopping process.

FIG. 7 illustrates a computer system suitable for implementing embodiments of the present disclosure.

### DETAILED DESCRIPTION

Embodiments may be embodied in systems, apparatuses, and methods for a personalized shopping, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for a personalized shopping environment that proactively identifies a customer entering a retail store and enables the customer to easily share a fashion profile with a chosen store associate for a limited time. In one embodiment, the customer's fashion profile may include selected demographic information, purchasing power, fashion aspirations and style preferences relevant to the store's retail domain. In a further embodiment, a fashion profile may include personalized product recommendations and other data (e.g., a customer's favorite drinks or language preferences).

According to one embodiment, a store associate may take notes during customer interaction, attach the notes to the customer's profile, as well as view notes posted by other associates during the customer's previous visits to the store. In a further embodiment, the customer may instantly rate the associate and overall in-store shopping experience. Designated customer service managers may observe, in real time, how their stores and individual associates are rated at customer service through a web-based analytics dashboard. In other embodiments, retailers may create targeted advertising campaigns personalized in accordance with customers' fashion profile, deliver personal advertisements to consumers' mobile or wearable devices and measure accurate click-through rate and purchase intent.

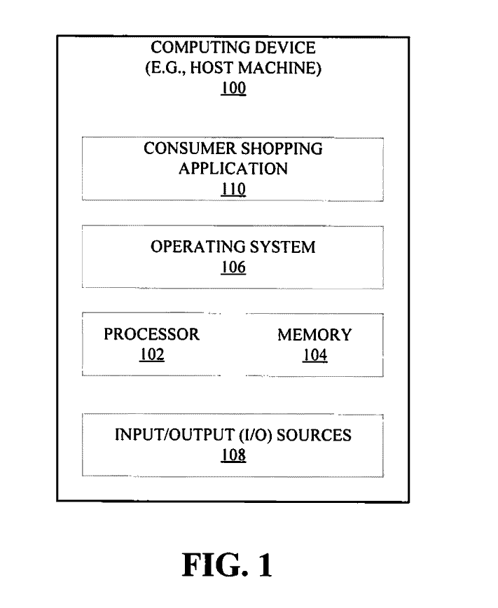

FIG. 1 illustrates one embodiment of a computing device 100 implementing a consumer shopping application component 110 of the personalized shopping mechanism. In one embodiment, computing device 100 serves as a host machine for hosting consumer shopping application 110 that includes a combination of any number and type of components for implementing personalized shopping at computing devices, such as computing device 100. In one embodiment, computing device 100 includes a wearable device.

In other embodiments, personalized shopping operations may be performed at a computing device 100 including large computing systems, such as mobile computing devices, such as cellular phones including smartphones, personal digital assistants (PDAs), tablet computers, laptop computers (e.g., notebook, netbook, Ultrabook™, etc.), e-readers, etc. In yet other embodiments, computing device 100 may include server computers, desktop computers, etc., and may further include set-top boxes (e.g., Internet-based cable television set-top boxes, etc.), global positioning system (GPS)-based devices, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

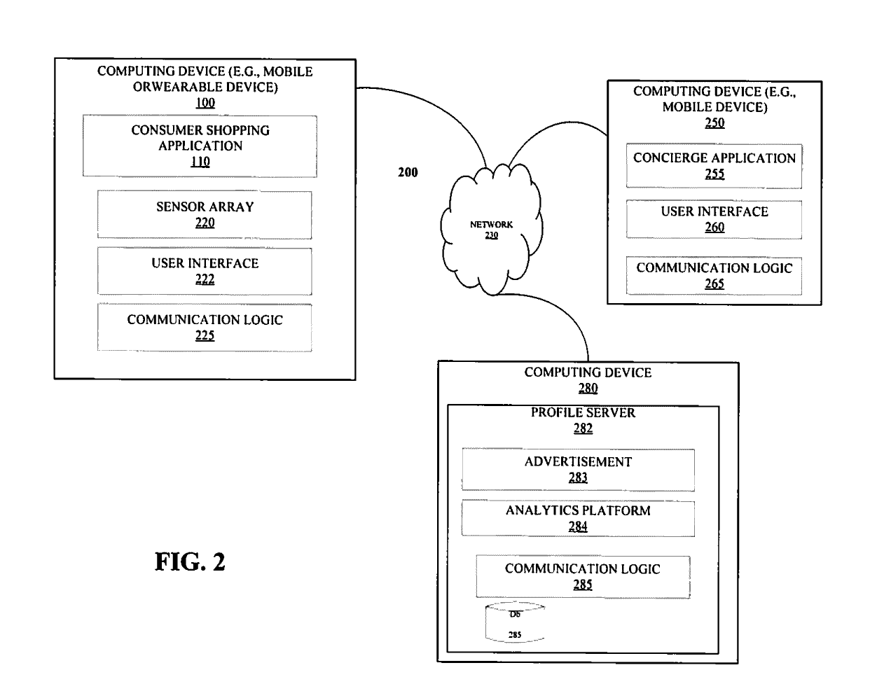

FIG. 2 illustrates one embodiment of a personalized shopping network 200. Personalized shopping network 200 includes computing device 100 having consumer shopping application 110, a computing device 250 having a store associate (or concierge) application component 255, and computing device 280 implementing a profile server 282. Throughout this document, terms like “logic”, “component”, “module”, “framework”, “engine”, “point”, and the like, may be referenced interchangeably and include, by way of example, software, hardware, and/or any combination of software and hardware, such as firmware.

It is contemplated that any number and type of components may be added to and/or removed from personalized shopping network 200 to facilitate various embodiments including adding, removing, and/or enhancing certain features. For brevity, clarity, and ease of understanding of personalized shopping network 200, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

Consumer shopping application 110 at computing device 100 enables a consumer to generate a fashion profile. In one embodiment, a fashion profile includes basic consumer demographic information, fashion aspirations and style preferences. In a further embodiment, consumer shopping application 110 converts the fashion profile into fashion analytics and uploads to profile server 282 at computing device 280. Additional functionality of consumer shopping application 110 will be discussed in more detail below.

Computing device 100 also includes a sensor array 220, which may include an image capturing device, such as a camera, implemented by shopping application 110. In a further embodiment, sensor array 220 may include other types of sensing components, such as context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), and the like.

User interface 222 provides for user interaction with computing device 100. In one embodiment, user interface 222 enables a consumer to interact with consumer shopping application 110. Communication logic 225 may be used to facilitate dynamic communication and compatibility between various computing devices, such as computing device 100 and computing devices 250 and 280 (such as a mobile computing device, a desktop computer, a server computing device, etc.), storage devices, databases and/or data sources, networks, such as network 230 (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), connectivity and location management techniques, software applications/websites, programming languages, etc., while ensuring compatibility with changing technologies, parameters, protocols, standards, etc.

Computing device 250 may also include a user interface 260 and communication logic 265 to facilitate operation of a concierge application component 255 of the personalized shopping mechanism. Communication logic 265 of computing device 250 may be similar to or the same as communication logic 225 of computing device 100 and may be used to facilitate the personalized shopping mechanism via network 230. Concierge application 255 enables a store associate (or fashion concierge) to create and upload an employee profile to profile server 282 at computing device 280. In a further embodiment, concierge application 255 is registered with a push notification service that enables concierge application 255 to receive consumer profile analytics from profile server 282 upon a consumer entering a store at which application 255 is being implemented. Additional functionality of concierge application 225 will be discussed in more detail below.

Computing device 280 also includes communication logic 285 to interface with computing devices 100 and 250. Communication logic 285 of computing devices 280 may be similar to or the same as communication logic 225 of computing device 100 and may be used to facilitate the personalized shopping mechanism via network 230. Further, logic 225, 265 and 285 may be arranged or configured to use any one or more of communication technologies, such as wireless or wired communications and relevant protocols (e.g., Wi-Fi®, WiMAX, Ethernet, etc.), to facilitate communication over one or more networks, such as network 230 (e.g., Internet, intranet, cloud network, proximity network (e.g., Bluetooth, etc.).

Profile server 282 manages fashion analytics data for consumers using applications 110. Profile server 282 may include any number and type of components, such as: advertisement module 283, analytics platform 284 and database 285. Advertisement module 283 enables the creation of targeted advertisement campaigns personalized in accordance with a customer's fashion profile. Additionally, advertisement module 283 delivers personal advertising (e.g., from private ad network software) to an application 110 at a mobile, or wearable, device 100, and measures accurate click-through rate and purchase intent.

Analytics platform 284 provides retailers with real-time analysis as to consumers' shopping experience and stores' staff performance, based on data received from consumer application 110. In a further embodiment, analytics platform 284 enables identification of customer service issues and actions to correct such issues. In yet a further embodiment, analytics platform 284 generates a predictive intelligence system to improve future consumer experiences. Examples of retail analytics enabled by this invention include pro-active monitoring of how stores and individual associates rate in customer service (e.g., per brand and location); optimization of associates' time management and availability; measurement of consumers' actions on the associate's recommendations, provision of product recommendation based on previous purchases, customer's fashion profile, retailer product marketing campaigns and purchases of consumers with similar fashion tastes; and customization of in-store digital signage to consumer's fashion aspirations. Database 285 stores data for advertisement module 283 and analytics platform 284.

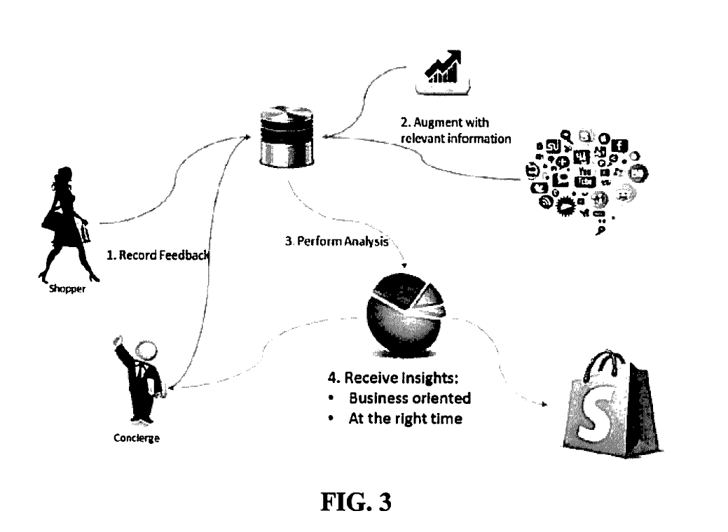

FIG. 3 illustrates one embodiment of an analytics platform 284 flow. First information from consumer application 110 and concierge application 255 flow into analytics platform 284. Subsequently, the data is augmented with relevant information from consumer's fashion profile and third party information, such as social networks and retail customer relationship management (CRM). Retailer product and campaign rules then flow into advertisement module 283. Analytics platform 284 subsequently performs data analysis and generates actionable insights (e.g., for consumers, concierges and brand/retail analysts). Finally, the information is disseminated to the interesting parties in a form of product recommendations, customer service alerts, etc.

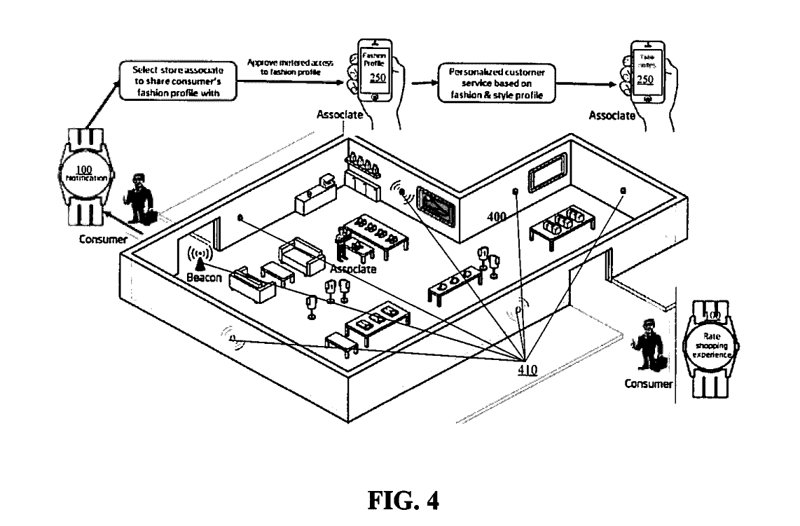

FIG. 4 illustrates one embodiment of a personalized shopping environment 400. In one embodiment, environment 400 is a retail store at which a consumer wearing device 100 enters. Upon entering device 100 detects signals from one or more beacons 410. In one embodiment, device 100 detects a BLE signal from beacons 410. However other embodiments may implement NFC communication. Upon beacon detection, the consumer selects a concierge, via profile server 282, with whom to share the consumer's fashion profile and approves metered access to the profile. The concierge then receives provides personalized customer service based on the consumer's fashion profile. Subsequently, the concierge may add one or more notes to the fashion profile based on interaction with the consumer, and the consumer may rate the shopping experience, both of which are stored at profile server 282 to update the consumer's fashion profile.

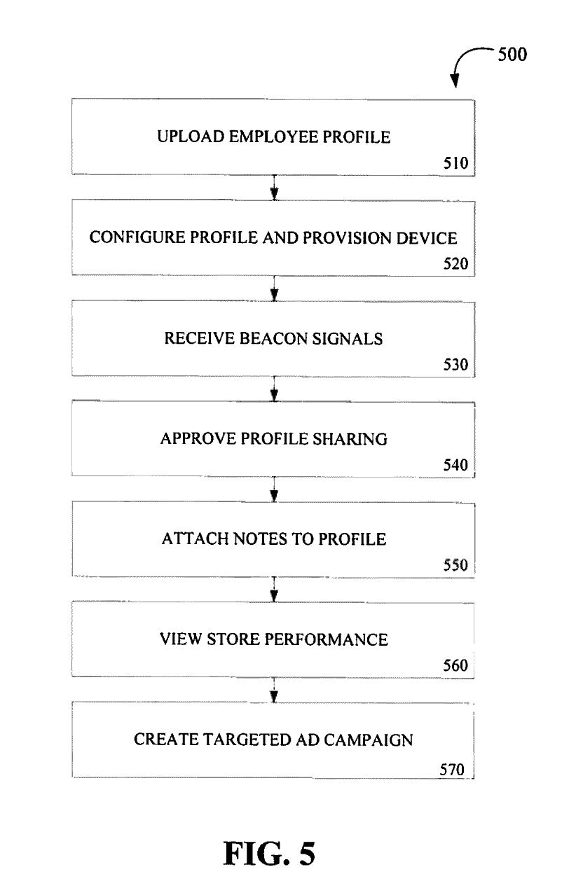

FIG. 5 is a flow diagram illustrating one embodiment of a process 500 performed by a personalized shopping mechanism. Process 500 may be performed by processing logic that may comprise hardware (e.g., circuitry, dedicated logic, programmable logic, etc.), software (such as instructions run on a processing device), or a combination thereof. The processes of method 500 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-4 may not be discussed or repeated here.

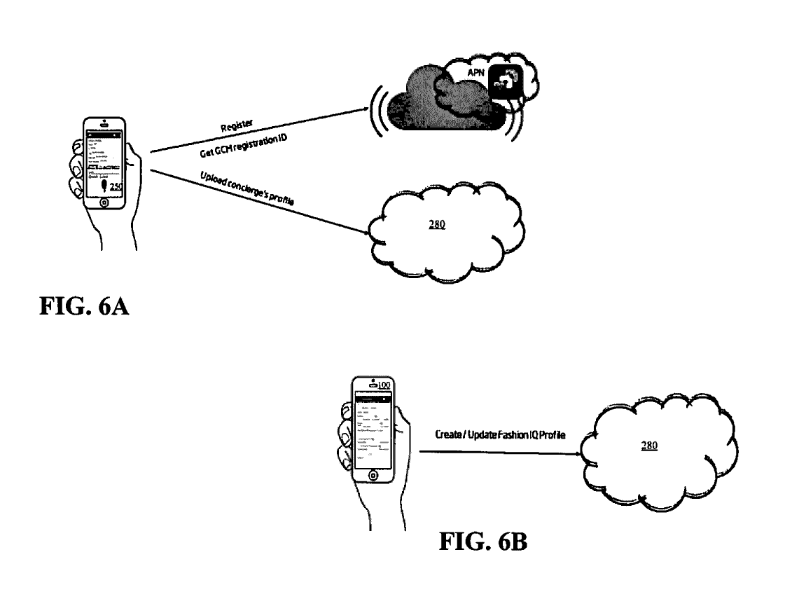

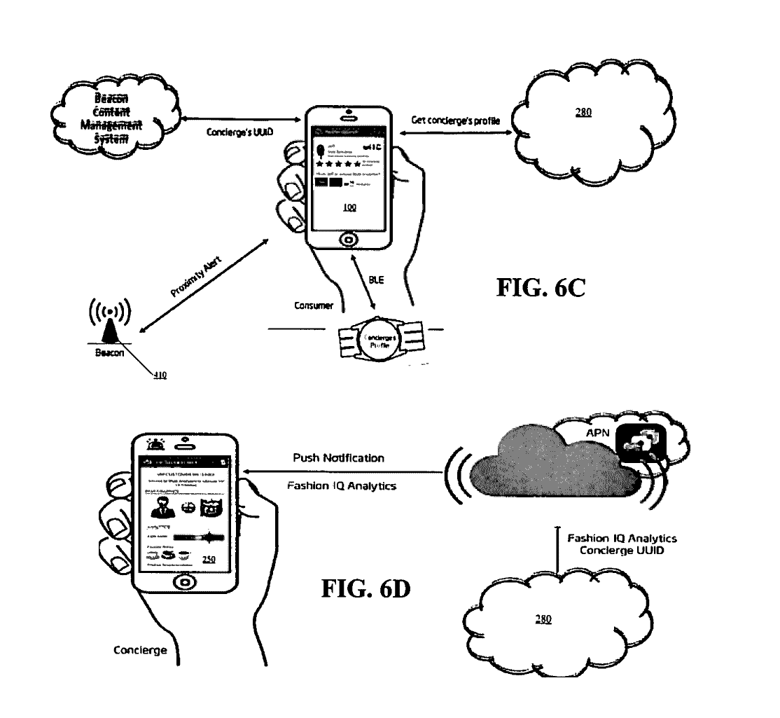

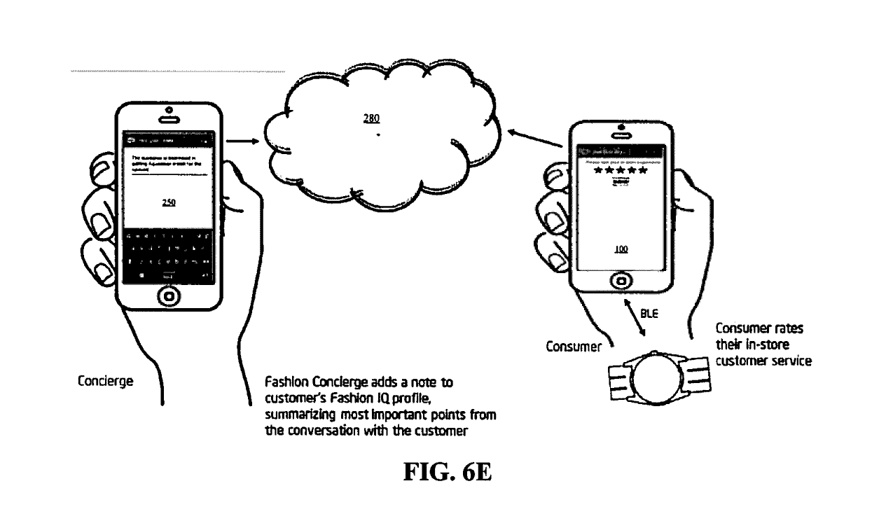

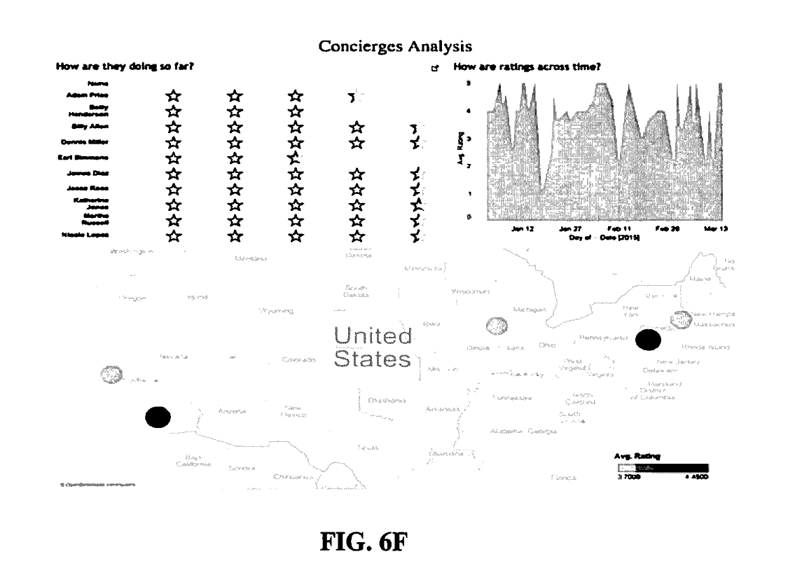

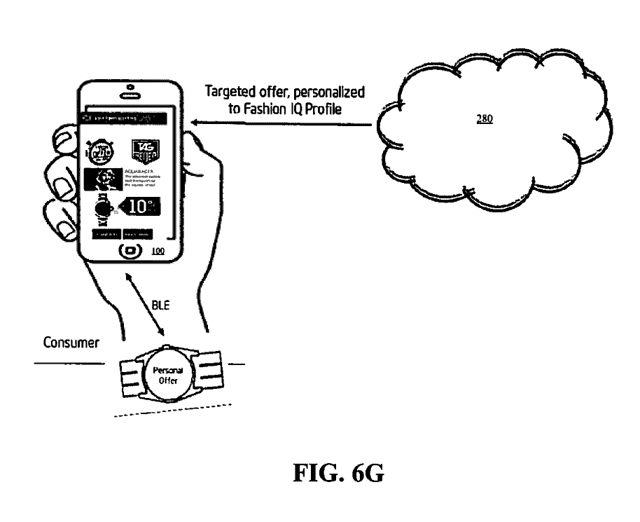

At processing block 510, a concierge uses application 255 to create and upload an employee profile to server 282. At this time the concierge's device 250 may also be seamlessly registered with Push Notification service. FIG. 6A illustrates one embodiment of the process performed at processing block 510. At processing block 510, a new consumer uses application 110 to configure a fashion profile to generate fashion analytics. The fashion analytics are then uploaded to it to Fashion IQ backend. In one embodiment, existing consumers have existing profiles that have been previously provisioned. FIG. 6B illustrates one embodiment of the process performed at processing block 520.

At processing block 530, a consumer wearing device 100 picks up a BLE signal from a beacon 410 upon the entrance to the retail store. Subsequently, application 110 on wearable device 100 prompts the consumer to share a fashion profile with one of the store associates. In such an embodiment, the consumer is presented with concierge information collected at processing block 510. FIG. 6C illustrates one embodiment of the process performed at processing block 530. At processing block 540, the consumer approves sharing their fashion profile for a period of time (e.g. 10 minutes) if interested in personal assistance from the concierge. Upon consumer's approval the personalized fashion analytics is delivered to concierge application 255 at device 250. FIG. 6D illustrates one embodiment of the process performed at processing block 540.

At processing block 550, a concierge attaches notes to the consumer's fashion profile upon completion of shopping experience, which are uploaded to profile server 282. For example, a note may indicate customer's purchasing intent of a particular product. In such an embodiment, the consumer has an opportunity to review and edit/delete notes at profile server via application 110. The consumer may subsequently use application 110 to rate their in-store shopping experience with one touch on device 100. FIG. 6E illustrates one embodiment of the process performed at processing block 550. At processing block 560, customer service managers may access profile server 282 for real time updates on how their stores and individual associates are rated at customer service via an analytics dashboard. FIG. 6F illustrates one embodiment of such an analytics dashboard.

At processing block 570, a retailer, via advertisement module 284, generates targeted advertising campaigns personalized in accordance with a customer's fashion profile, delivers personal advertisements (from the private ad network software) to application 110 at a consumer's device 100 and measures accurate click-through rate and purchase intent. FIG. 6G illustrates one embodiment of the process performed at processing block 570.

The above described the personalized shopping mechanism optimizes a person-to-person aspect of shopping experience. The power of personal recommendation from a human stylist that has detailed knowledge of the customer's tastes and preferences is a key aspect of shopping experience that cannot be matched online. The ability of retailers to continuously monitor and drive improvements into their customer service via real-time analytics significantly improves customer satisfaction, brand loyalty and will ultimately attract more customers into the stores

Further, the personalized shopping mechanism enables retailers to offer personalized and highly efficient in-store customer service, significantly improving customer satisfaction, brand loyalty and attracting more customers into the stores. Moreover, the personalized shopping mechanism pro-actively puts personalized fashion analytics at the fingertips of a store associate, instantly turning them into personal style concierges for the consumer they might have never seen before. The shopping experience reserved for VIP customers at exclusive boutique shops can now be offered at any retailer to their most valuable clientele, significantly improving customer satisfaction and brand loyalty. Consumers may instantly rate their shopping experience, providing retailers with actionable customer satisfaction insights.

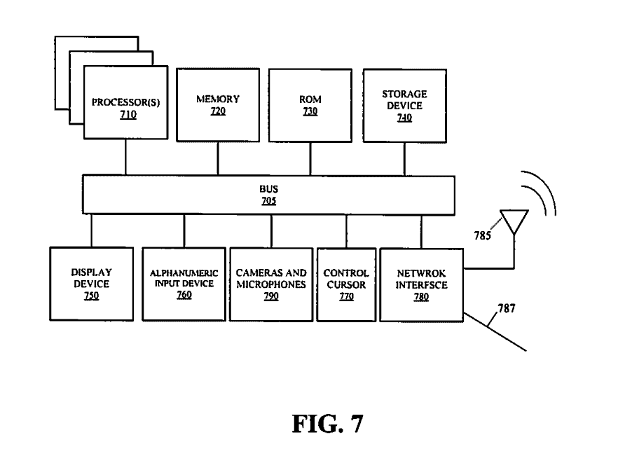

FIG. 7 illustrates a computer system suitable for implementing embodiments of the present disclosure. Computing system 700 includes bus 705 (or, for example, a link, an interconnect, or another type of communication device or interface to communicate information) and processor 710 coupled to bus 705 that may process information. While computing system 700 is illustrated with a single processor, electronic system 700 and may include multiple processors and/or co-processors, such as one or more of central processors, graphics processors, and physics processors, etc. Computing system 700 may further include random access memory (RAM) or other dynamic storage device 520 (referred to as main memory), coupled to bus 705 and may store information and instructions that may be executed by processor 710. Main memory 720 may also be used to store temporary variables or other intermediate information during execution of instructions by processor 710.

Computing system 700 may also include read only memory (ROM) and/or other storage device 530 coupled to bus 705 that may store static information and instructions for processor 510. Date storage device 740 may be coupled to bus 705 to store information and instructions. Date storage device 740, such as magnetic disk or optical disc and corresponding drive may be coupled to computing system 700.

Computing system 700 may also be coupled via bus 705 to display device 750, such as a cathode ray tube (CRT), liquid crystal display (LCD) or Organic Light Emitting Diode (OLED) array, to display information to a user. User input device 760, including alphanumeric and other keys, may be coupled to bus 705 to communicate information and command selections to processor 710. Another type of user input device 760 is cursor control 770, such as a mouse, a trackball, a touchscreen, a touchpad, or cursor direction keys to communicate direction information and command selections to processor 710 and to control cursor movement on display 750. Camera and microphone arrays 790 of computer system 700 may be coupled to bus 705 to observe gestures, record audio and video and to receive and transmit visual and audio commands.

Computing system 700 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 780 may include, for example, a wireless network interface having antenna 785, which may represent one or more antenna(e). Network interface(s) 780 may also include, for example, a wired network interface to communicate with remote devices via network cable 787, which may be, for example, an Ethernet cable, a coaxial cable, a fiber optic cable, a serial cable, or a parallel cable.

Network interface(s) 780 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 780 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 780 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 700 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes a network comprising a profile server to manage fashion analytics data for a plurality of consumers and a plurality of concierge profiles, a first computing device having a consumer application to generate a consumer fashion profile and communicate fashion analytics data associated with the consumer fashion profile with the profile server and a second computing device having a concierge application to generate a first concierge profile and communicate the first concierge profile and the fashion analytics data with the profile server.

Example 2 includes the subject matter of Example 1, further comprising one or more beacons, wherein the first computing device detects a signal upon becoming within proximity of at least one of the one more beacons.

Example 3 includes the subject matter of Example 2, further comprising one or more beacons, wherein the first computing device detects a signal upon becoming within proximity of at least one of the one more beacons.

Example 4 includes the subject matter of Example 3, wherein the concierge application receives the fashion analytics data associated with the consumer fashion profile from the profile server.

Example 5 includes the subject matter of Example 4, wherein the concierge application generates notes to be added to the fashion profile and transmits the notes to the profile server.

Example 6 includes the subject matter of Example 5, wherein the profile server updates the fashion analytics data associated with the consumer fashion profile based on the notes from the concierge application.

Example 7 includes the subject matter of Example 6, wherein the profile server transmits the updated analytics data to the consumer application.

Example 8 includes the subject matter of Example 7, wherein the consumer application generates a service rating and transmits the service rating to the profile server.

Example 9 includes the subject matter of Example 8, wherein the profile server updates the concierge profile based on the service rating.

Example 10 includes the subject matter of Example 9, wherein the profile server comprises an analytics dashboard to enable viewing of the service rating.

Example 11 includes the subject matter of Example 1, wherein the profile server comprises an advertisement module to generate personalized advertising in accordance with the consumer fashion profile and to transmit the personalized advertising to the consumer application.

Example 12 includes the subject matter of Example 11, wherein the advertisement module measures click-through rate and purchase intent performed at the consumer application.

Example 13 includes the subject matter of Example 1, wherein the profile server comprises an analytics platform to provide real-time analysis based on information included in the fashion analytics data.

Example 14 includes the subject matter of Example 13, wherein the analytics platform generates real time analytics including corrective actions responsive to the fashion analytics data.

Some embodiments pertain to Example 15 that includes a method comprising a profile server receiving a consumer fashion profile from a consumer device, the profile server generating fashion analytics data based on the consumer fashion profile, the profile server receiving a concierge profile from a concierge device and the profile server communicating the first concierge profile and the fashion analytics data between the consumer device and the concierge device.

Example 16 includes the subject matter of Example 15, wherein the profile server communicating between the consumer device and the concierge device comprises the profile server transmitting a plurality of concierge profiles to the consumer device.

Example 17 includes the subject matter of Example 16, wherein the profile server communicating between the consumer device and the concierge device further comprises profile server transmitting the fashion analytics data to the concierge device.

Example 18 includes the subject matter of Example 17, further comprising the profile server receiving notes to be added to the fashion profile from the concierge device and updating fashion analytics data associated with the consumer fashion profile based on the notes.

Example 19 includes the subject matter of Example 18, further comprising the profile server transmitting the updated analytics data to the consumer application.

Example 20 includes the subject matter of Example 19, further comprising the profile server receiving a service from the consumer device.

Example 21 includes the subject matter of Example 15, wherein the profile server generates personalized advertising in accordance with the consumer fashion profile and to transmit the personalized advertising to the consumer application.

Some embodiments pertain to Example 22 that includes at least one machine-readable medium comprising a plurality of instructions that in response to being executed on a computing device, causes the computing device to carry out operations comprising receiving a consumer fashion profile from a consumer device, generating fashion analytics data based on the consumer fashion profile, receiving a concierge profile from a concierge device and communicating the first concierge profile and the fashion analytics data between the consumer device and the concierge device.

Example 23 includes the subject matter of Example 22, comprising a plurality of instructions that in response to being executed on a computing device, causes the computing device to further carry out operations comprising transmitting a plurality of concierge profiles to the consumer device.

Example 24 includes the subject matter of Example 23, comprising a plurality of instructions that in response to being executed on a computing device, causes the computing device to further carry out operations comprising transmitting the fashion analytics data to the concierge device.

Example 25 includes the subject matter of Example 24, comprising a plurality of instructions that in response to being executed on a computing device, causes the computing device to further carry out operations comprising receiving notes to be added to the fashion profile from the concierge device and updating fashion analytics data associated with the consumer fashion profile based on the notes.

Some embodiments pertain to Example 26 that includes a system comprising means for receiving a consumer fashion profile from a consumer device, means for generating fashion analytics data based on the consumer fashion profile, means for receiving a concierge profile from a concierge device and means for communicating the first concierge profile and the fashion analytics data between the consumer device and the concierge device.

Example 27 includes the subject matter of Example 26, further comprising means for transmitting a plurality of concierge profiles to the consumer device.

Example 28 includes the subject matter of Example 27, further comprising means for transmitting the fashion analytics data to the concierge device.

Example 29 includes the subject matter of Example 28, further comprising means for receiving notes to be added to the fashion profile from the concierge device and means for updating fashion analytics data associated with the consumer fashion profile based on the notes.

Some embodiments pertain to Example 30 that includes at least one machine-readable medium comprising a plurality of instructions that in response to being executed on a computing device, causes the computing device to carry out the method of claims 15-21.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A network comprising:
a profile server to manage fashion analytics data for a plurality of consumers and a plurality of concierge profiles;
a first computing device having a consumer application to generate a consumer fashion profile and communicate fashion analytics data associated with the consumer fashion profile with the profile server; and
a second computing device having a concierge application to generate a first concierge profile and communicate the first concierge profile and the fashion analytics data with the profile server.

2. The network of claim 1, further comprising one or more beacons, wherein the first computing device detects a signal upon becoming within proximity of at least one of the one more beacons.

3. The network of claim 2, wherein the consumer application receives the plurality of concierge profiles upon detecting the beacon and selects the first concierge profile.

4. The network of claim 3, wherein the concierge application receives the fashion analytics data associated with the consumer fashion profile from the profile server.

5. The network of claim 4, wherein the concierge application generates notes to be added to the fashion profile and transmits the notes to the profile server.

6. The network of claim 5, wherein the profile server updates the fashion analytics data associated with the consumer fashion profile based on the notes from the concierge application.

7. The network of claim 6, wherein the profile server transmits the updated analytics data to the consumer application.

8. The apparatus of claim 7, wherein the consumer application generates a service rating and transmits the service rating to the profile server.

9. The network of claim 8, wherein the profile server updates the concierge profile based on the service rating.

10. The network of claim 9, wherein the profile server comprises an analytics dashboard to enable viewing of the service rating.

11. The network of claim 1, wherein the profile server comprises an advertisement module to generate personalized advertising in accordance with the consumer fashion profile and to transmit the personalized advertising to the consumer application.

12. The network of claim 11, wherein the advertisement module measures click-through rate and purchase intent performed at the consumer application.

13. The network of claim 1, wherein the profile server comprises an analytics platform to provide real-time analysis based on information included in the fashion analytics data.

14. The network of claim 13, wherein the analytics platform generates real time analytics including corrective actions responsive to the fashion analytics data.

15. A method comprising:
a profile server receiving a consumer fashion profile from a consumer device;
the profile server generating fashion analytics data based on the consumer fashion profile;
the profile server receiving a concierge profile from a concierge device; and
the profile server communicating the first concierge profile and the fashion analytics data between the consumer device and the concierge device.

16. The method of claim 16, wherein the profile server communicating between the consumer device and the concierge device comprises the profile server transmitting a plurality of concierge profiles to the consumer device.

17. The method of claim 16, wherein the profile server communicating between the consumer device and the concierge device further comprises profile server transmitting the fashion analytics data to the concierge device.

18. The method of claim 17, further comprising:
the profile server receiving notes to be added to the fashion profile from the concierge device; and
updating fashion analytics data associated with the consumer fashion profile based on the notes.

19. The method of claim 18, further comprising the profile server transmitting the updated analytics data to the consumer application.

20. The method of claim 19, further comprising the profile server receiving a service from the consumer device.

21. The method of claim 15, wherein the profile server generates personalized advertising in accordance with the consumer fashion profile and to transmit the personalized advertising to the consumer application.

22. At least one machine-readable medium comprising a plurality of instructions that in response to being executed on a computing device, causes the computing device to carry out operations comprising:
receiving a consumer fashion profile from a consumer device;
generating fashion analytics data based on the consumer fashion profile;
receiving a concierge profile from a concierge device; and
communicating the first concierge profile and the fashion analytics data between the consumer device and the concierge device.

23. The machine-readable medium of claim 22, comprising a plurality of instructions that in response to being executed on a computing device, causes the computing device to further carry out operations comprising transmitting a plurality of concierge profiles to the consumer device.

24. The machine-readable medium of claim 23, comprising a plurality of instructions that in response to being executed on a computing device, causes the computing device to further carry out operations comprising transmitting the fashion analytics data to the concierge device.

25. The machine-readable medium of claim 24, comprising a plurality of instructions that in response to being executed on a computing device, causes the computing device to further carry out operations comprising:
the profile server receiving notes to be added to the fashion profile from the concierge device; and
updating fashion analytics data associated with the consumer fashion profile based on the notes.
